(19) United States
(12) Patent Application Publication
(10) Pub. No.: US 2007/0036904 A1
(43) Pub. Date: Feb. 15, 2007

(54) Method for coating a paper/board web

(76) Inventors: Heikki Vatanen, Järvenpää (FI); Timo Nurmiainen, Järvenpää (FI)

Correspondence Address: STIENNON & STIENNON, 612 W. MAIN ST., SUITE 201, P.O. BOX 1667, MADISON, WI, 53701-1667, US

(21) Appl. No.: 10/598,181

(22) PCT Filed: Feb. 25, 2005
(86) PCT No.: PCT/FI05/50051

§ 371 Date: Sep. 20, 2006

(30) Foreign Application Priority Data
Feb. 25, 2004 (FI) 20045057

(51) Int. Cl. B05D 1/30; B05C 3/02

(52) U.S. Cl. 427/420; 118/410; 427/355

(57) ABSTRACT

A paper/board web is coated with a plane-fed curtain coater having a nozzle beam (40) with at least one feed chamber (12) and a nozzle slot (30) in connection therewith for feeding at least one layer of coating material onto a flow plane (35) established by the nozzle beam (40). The cross-thickness profile of said at least one coating material layer (2) on top of the flow plane (35) downstream of the feed slot (30) associated with the discussed layer is determined, and, on the basis thereof, the feed rate of the coating material layer from the feed chamber (12) to the feed slot (30) is subjected to a manipulation profiled crosswise of a web (W) to achieve a desired cross-profile for the at least one coating material layer.

The present invention relates to a method of coating a paper/board web with a plane-fed curtain coater, comprising a nozzle beam provided with at least one feed chamber and a nozzle slot in connection therewith for feeding at least one layer of coating material onto a flow plane established by the nozzle beam.

The invention is aimed at providing an improvement in the control of a thickness and in the regulability of a cross-profile in the individual coating layers of a curtain coater intended for applying the coating paste of a paper/board web.

Curtain coaters can be categorized in slot-fed and plane-fed coaters. In a plane-fed coater, the coating material is fed by means of a nozzle unit onto an inclined plane, along which it flows towards a lip of the plane, resulting in a curtain as the coating trickles off the lip of the plane. The resulting curtain of coating material is controlled by means of an edge guide which is located, as suggested by its name, at the edge of a feeding lip. The present invention is particularly directed to such a plane-fed curtain coater.

A common problem with prior art curtain coaters relates to controlling in various running conditions the cross-profile of a coating material for its application to a presently coated web. There are no conventional means to provide an effective and active control over the coating profile. The problems apply both to the control of a single coating material layer and to the control of an overall cross-coating profile in the case of a multilayer coating. In multilayer coating, the coating is formed from a number of superimposed layers of coating material.

It is prior known that the overall profile of a coating can be influenced in the designing stage of a coating frame as the shape of feed channels in the nozzle beam is decided. As the properties and/or feed rate of coating materials subsequently change, the changes have a clear impact on a cross-profile that cannot be corrected any more. Likewise, inaccuracies in manufacturing have an irreversible impact on the profile.

Regulation is also possible to provide a reasonably good cross-profile for a single layer by using an experimentally or mathematically predetermined by-pass rate. The term by-pass refers to that portion of a flow of coating material fed into a feed chamber, which is returned from the other, downstream end of the feed chamber back to the supply or a storage bin. The purpose of a coating material by-pass is to ensure that a flow rate of coating material exceeding a given minimal rate be sustained in flow channels in a nozzle unit, also in its end facing the flow of coating material. The purpose of this is to avoid precipitation of a coating material and build-up of deposits on the walls of flow channels. As the properties of a coating material change, this by-pass rate must be rectified by using correction factors. These provide compensation for defects resulting, for example, from variations in viscosity and dry content. However, accuracies of measurement and regulation can be at such a modest level that a desired profile cannot be obtained in a controlled manner in all running conditions.

Finnish patent application FI 20035149 discloses an arrangement, which enables the optimization of a cross-coating profile for a precisely particular grade of coating material and feed rate. In addition, optimization can even be performed within a considerable range. Yet, when deviating from this optimized feed rate or when modifications are made to the properties of a coating material, the cross-profile becomes defective again.

The use of a multilayer coating process results in further problems in terms of the uniformity and overall profile of a coating. Each individual layer has its own specific cross-profile, which in turn depends especially on the overall feed rate of a coating layer. The use of a multilayer coating process is quite likely to develop a condition in which the cross-profiles of all layers are askew and even in the same direction and, thus, the overall profile jointly formed by the coating material layers no longer satisfies all requirements.

On the other hand, Finnish patent application FI 20045056 discloses a method for regulating the overall profile of a coating. The method enables optimization of the overall profile of a nozzle beam, i.e. the cross-profile of an entire coating, by regulating one or more individual coating material layers. However, the described method does not enable optimization of the cross-profile of a single coating material layer. Neither the thickness of a single layer nor the shape of its cross-profile can be adjusted as desired, since the regulation is performed on the basis of a measured cross-profile of the entire coating. The regulation does enable providing a cross-profile as desired explicitly for the entire coating. Hence, the cross-profiles of an individual coating material layer or layers may still remain disturbingly poor.

It should further be noted that the measurement of a coating to be performed for the regulation in a method of the cited application is effected from the surface of a paper/board web. Measuring from paper is generally a vulnerable process and all measurement-inflicted defects have a further impact on the uniformity of a coating as a result of incorrect regulation parameters caused thereby. It is very difficult, if not outright impossible to effect a reliable and accurate measurement for the thickness of a single layer from the surface of a web.

It is an objective of the present invention to provide an improved method of coating a paper/board web with a curtain coater, said method enabling the formation of individual coating material layers with desired thicknesses and cross-profiles, as well as the formation of a consistent coating over the entire length of a nozzle unit crosswise of a web to be coated, as well as also effective and quick regulability for various coating materials and feed rates while the run is in progress. In order to accomplish this objective, a method of the invention is characterized in that the method comprises determining the cross-thickness profile of at least one coating material layer on top of a flow plane downstream of a feed slot associated with the discussed layer, and that, on the basis of the thus discovered cross-thickness profile of said at least one coating material layer, the feed rate of the coating material layer from a feed chamber to a feed slot is subjected to a manipulation profiled crosswise of a web to achieve a desired cross-profile for said at least one coating material layer.

Thus, the invention is based on measuring a crosswise profile for the thicknesses of individual coating material layers directly from the plane of a nozzle beam, even prior to application. Likewise, in its preferred embodiment, the inventive method comprises both a constriction of the coating material flow between a feed chamber and a feed slot based on said measurements and thereby an automation of the regulation in a nozzle beam. The method enables regulating the thickness and cross-profile of individual coating material layers locally during the run across the entire width of a web. The local nature of regulation refers in this concept to the fact that the regulation can be performed crosswise of the web at desired intervals and, especially, independently of other intervals. Hence, in other words, the regulation of a profile in a coating material layer can be set for each of such intervals at a desired value, essentially regardless of other sections of the profile in a cross-web direction.

The method endeavours particularly to rectify relative defects in a cross-coating profile in order to shape the profile as desired. In addition to individual coating material layers, the inventive method enables simultaneously also a desired thickness and cross-profile to be obtained for the entire coating. It is a major advantage that the measurement is effected directly from the flow plane of a nozzle beam for accurate and unaffected measuring results. Thus, the measurement and measuring results cannot be affected in any way by the properties of a paper being coated. Another advantage of the invention is that the type of coating material has no significance in terms of regulation and its accuracy.

Preferred embodiments of the invention are set forth in dependent claims 2-8. A method of the invention can be applied according to the independent claim 9, especially to such a plane-fed curtain coater which comprises a nozzle beam provided with at least two feed chambers and nozzle slots in connection therewith for feeding at least two layers of coating material onto a flow plane established by the nozzle beam, said method being characterized by what is set forth in the characterizing clause of claim 9. An arrangement of the invention is turn characterized by what is set forth in the characterizing clause of the independent claim 10.

Regarding its details, features and advantages, the invention is illustrated more precisely in the following description of an exemplary embodiment and in the accompanying drawing, in which:

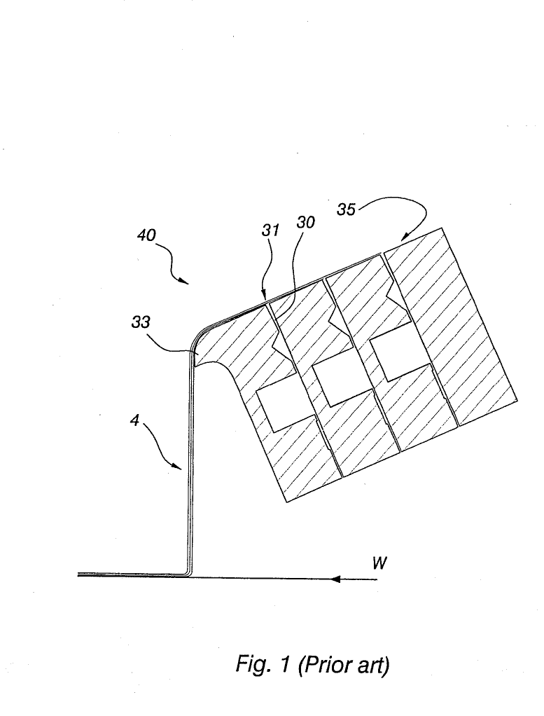

FIG. 1 shows a prior art nozzle beam used for a multilayer coating process,

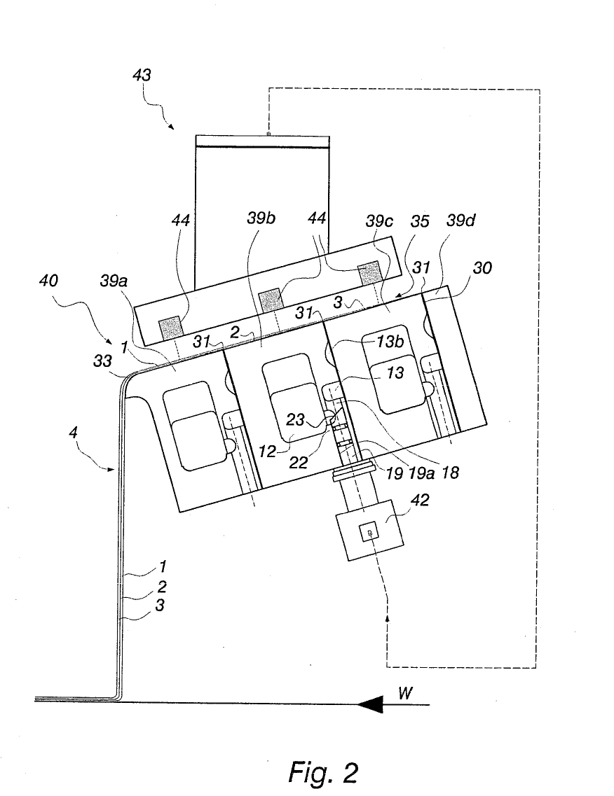

FIG. 2 shows, in a basically schematic, yet not to-scale view, an arrangement according to the method for coating a paper/board web, in which the profile of individual coating material layers is controlled,

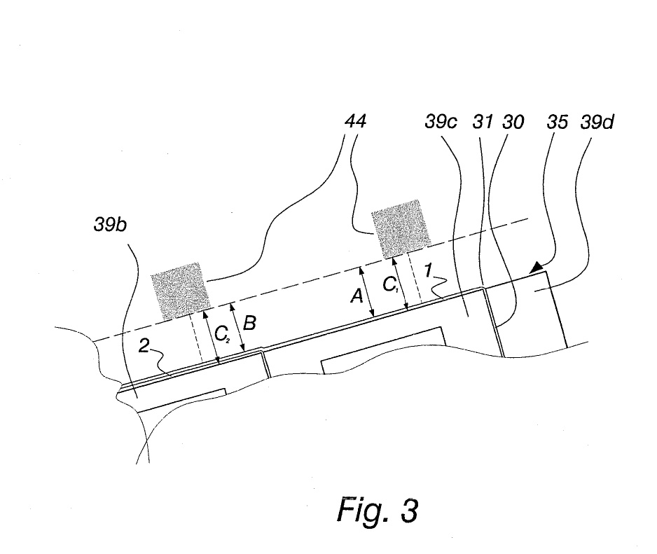

FIG. 3 shows in a close-up view the thickness of coating material layers directly from the flow plane of a nozzle beam,

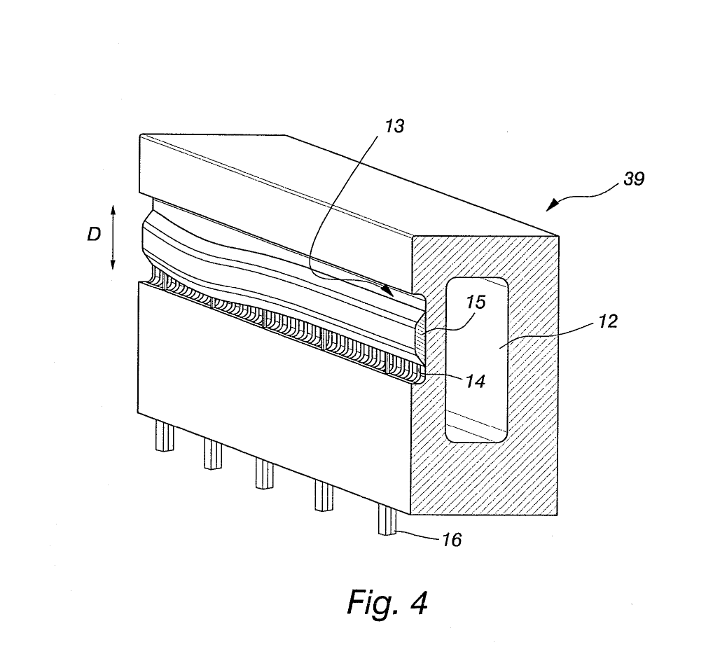

FIG. 4 shows, in a perspective view, a nozzle beam of another design for conducting a method of the invention.

FIG. 1 illustrates a nozzle beam 40 of the prior art used for a multilayer coating process. The coating is comprised of individual layers of coating material, which are fed from feed slots 30 of the nozzle beam onto a flow plane 35 and trickled further from a feeding lip 33 of the nozzle beam in the form of a coating curtain 4 onto the surface of a web W. The nozzle beam has its structure and feed channel system optimized for a combination of certain type coating materials and for feed rates and by-pass rates thereof. When the optimal ranges of running parameters are maintained, the result is usually a reasonably consistent cross-coating profile of a desired thickness. However, all deviations from these optimal values cause undesired changes in the cross-profile of both individual coating material layers as well as that of the entire coating.

In reference to FIG. 2, there is basically shown an arrangement applying a method of the invention for coating a paper/board web. This embodiment of the invention comprises a nozzle beam 40, consisting of four nozzle beam members 39a, 39b, 39c, 39d and capable of forming a coating curtain 4 for its application to a web W. In the present embodiment, the application beam 40 is provided with three feed chambers 12, from which the coating material is expelled by way of equalizing chambers 13 and 13b to nozzle slots corresponding to the feed chambers. The flow of coating material providing each individual layer of coating material for the coating proceeds along a respective feed chamber towards the opposite end which is optionally provided with a by-pass route for a coating material by-pass.

In this embodiment of the invention, the coating curtain 4 is made up of three individual coating material layers 1, 2 and 3. It should be emphasized at this point that neither the number of individual coating material layers nor which ones of said layers will be regulated with a method of the invention are significant as such in terms of the present method. The number of feed chambers 12 and nozzle slots 30 connected therewith in the nozzle beam 40 can naturally be considerably more than two or three as shown in the depicted exemplary embodiment.

For the sake of clarity, FIG. 2 only depicts elements associated with the nozzle member 39b for regulating a coating material. Thus, these are used for manipulating a coating material feed rate for the coating material layer 2 to regulate thereby its cross-profile and thickness. The corresponding elements provided for the layers 1 and 3 are not shown in this context. The subsequently described regulation regarding a single individual coating material layer can be provided just as well for all individual layers, if necessary.

The amount of coating material, realized for the middle layer 2 and to be applied to the web W, can be calculated as a difference between the total flow rate of coating material and the by-pass flow rate adjusted therefrom. A measurement for the feed rate of a coating material is provided for each individual layer of coating material. This can be used as a basis for setting the basic total amount of coating material as desired.

Local adjustment of the middle layer in terms of its cross-profile as well as its thickness is performed in response to a local thickness of the coating material layer determined from the flow plane. Determination of the thickness of coating material layers can be effected either by measuring the thickness directly or by determining the thickness of such layers with an indirect measuring procedure.

The thickness of a coating material layer being trickled along the flow plane 35 of a nozzle beam can thus be measured directly as such from the plane. The measurement can be performed by using preferably sensors based on a non-contact measurement. The sensors measure separately a distance both from a response level, i.e. in this case from the surface of a flow plane in a nozzle beam, and from the top surface of the topmost coating material layer.

FIG. 3 shows schematically in a fragmentary close-up view a measurement for the thickness of coating material layers from a flow plane 35 of the nozzle beam. Use can be preferably made of prior art sensors 44 or sensor groups whose operation is based for example on eddy-current measuring and capacitive measuring. A distance A, B from the sensor 44 to the top surface of a coating present on the flow plane of a nozzle beam is discovered by means of capacitive measuring. A distance C to the flow plane 35 of a nozzle beam can be performed instead by means of eddy-current measuring having a higher immunity to interference. Such integrated sensors, based on capacitive and eddy-current measuring, are commercially available.

The measuring accuracy achieved in such sensors can be even less than 1 micrometer. While trickling along the flow plane 35, the coating material layer has a thickness which is typically in the order of 0,5-1 mm. Accordingly, the sensors make it possible to clearly detect variations of less than one percent in the thickness of a coating material layer upon a flow plane. What should be particularly appreciated in this context is that the thickness of coating material layers on a flow plane is generally several ten-fold with respect to the final thickness of such layers after application to a web. Thus, another advantage in performing a measurement from the flow plane of a nozzle beam is that absolute errors occurring in measuring methods do not result in major relative defects in the thickness of the layers.

It is easy to work out the thickness of individual coating material layers from measuring results obtained from the sensors. Measurement is most conveniently conducted after each feed slot 30 to discover the thickness of any individual layer as a difference between the measuring results. In reference to FIG. 3, the thickness of a layer 1 is obtained as difference between distances C₁, and A and the thickness of a layer 2 as a difference between distances C₂ and B after subtracting the thickness of the layer 1. The same procedure can be used for determining the thicknesses of other coating material layers, as well. When measurements are conducted across the entire width of a web in the longitudinal direction of a nozzle beam (thus perpendicularly to the image plane in FIGS. 1-3), the overall cross-profile of each layer is discovered. The feed rate is regulated with the sensors 44 by means of a feedback provided in the nozzle beam 40. On the basis of measuring data received from the sensors, the feed rates of each feed slot 30 are regulated locally to provide a desired cross-layer profile.

According to a second embodiment of the invention, the determination of thickness profiles for coating material layers can be conducted also indirectly. It has been observed, namely, that the surface speed of a coating trickling down a flow plane is in clear correlation to the thickness and thus also to the feed rate of the coating. In this context, the surface speed represents a speed, which is parallel to the flow plane and which also essentially relates to the lengthwise direction of a paper/board machine, either in the traveling direction of a web or in the reverse direction, depending on which way the flow plane itself has been adapted to incline.

Correlations between the surface speed of a coating trickling along a flow plane and the flow rate and thickness of a coating are also supported by formulae available in literature, regarding the flow of a fluid along a smooth inclined plane. Speed variations of a slip with respect to flow rate are derivable at least for a rough estimate for example from the following formula (Kistler, S. F. and Schweizer, P. M. “Liquid Film Coating”, Chapman & Hall, 1997):
Hₛ=(3*μ* Q/(ρ*g* sin β))^{1/3}, wherein

Hₛ=thickness of film

μ=viscosity

Q=flow rate/unit of width

g=acceleration of gravity

β=trickling angle relative to horizon

ρ=density of material

Practical measurements have revealed clear correlations between flow rate variations of a coating material and surface speeds of a coating. Another aspect to be observed in measurements is a discrepancy between the surface speed of a coating and the average speed of the coating. The flow rate or speed of a coating at the very top of coating layers is by a certain correction factor higher than the speed deeper within the coating material layers. On the basis of practical experiments, it is a general conclusion that, as the flow rate of a coating material increases, approximately a third of the relative flow rate change is applied to the thickness of the coating layer upon a flow plane and approximately two thirds are transferred to the flow rate of the coating layer, i.e. the thickness and the flow rate increase in proportion as pointed out above. The more accurate values of correlations depend e.g. on the properties of coating materials, thicknesses of coating layers, inclination of a plane, as well as other factors pertinent e.g. to running parameters.

With regard to flow-rate based determination of the cross-profile of a coating material layer, it is also essential that it is also based, above all, on discrepancies observed in a cross-web direction, hence, in this case, on differences in speed. In other words, what is even more important than precise determination of absolute thicknesses of the coating material layers determined by means of measurements is that, in order to define the cross-profiles of coating layers, it is just these relative differences in a cross-web direction that are accurately discovered with regard to flow rates and thereby local thicknesses.

Measuring the actual surface speed can be conducted preferably by means of a non-contact measurement based on laser technology. Reliable and robust laser measuring equipment of the prior art suitable for measuring is abundantly available in the marketplace. In addition to precise rate assessment, speed and economy, an advantage offered by laser measurement is also a possibility of both setting up the measuring equipment at a substantial distance from the actual object to be measured, i.e. a flow plane, and protecting the same also otherwise from nuisance factors existing in paper machine environment, such as from becoming soiled.

The measurement of surface speed is conducted basically the same way as described above in reference to the measurement effected by means of sensors according to FIG. 2. Thus, the determination of cross-profiles with regard to an individual coating material layer is effected by subtracting the thicknesses of preceding coating material layers from the respective thicknesses calculated on the basis of received speed measurements. The surface speed measuring point is preferably always just before the next feed slot outlet opening 31. At this point, the flow rates of coating layers have established themselves after the supplement of a coating material effected in the preceding feed slot 30. Most conveniently, the measurement is conducted a few millimeters before the next feed slot and respectively at least 15 millimeters after the previous feed slot.

The data obtained in the determination of a cross-profile for coating material layers is transmitted further from the measuring apparatus to an automatic actuator 42. The actuator in turn operates elements 19, which are disposed in the nozzle beam 40 and which provide a further direct influence on the flow of a coating material. A local fine adjustment for the thickness of a middle layer 2 is in practice conducted by manipulating the flow of a coating material into the feed slot 30 in the nozzle beam 40. In the embodiment of FIG. 2, the flow is regulated by modifying the effective area of a flow channel between the feed chamber 13 and the feed slot 30. In a highly preferred embodiment of the invention, the adjustment of a feed rate is conducted in the vicinity of a equalizing chamber 13 provided between the feed chamber 12 and the feed slot 30. The flow of a coating material from the feed chamber 12 to the equalizing chamber 13 is constricted in feed holes 18 provided therebetween.

Each feed hole 18 is formed with a boring 19a, which merges into a vertical section of the feed hole 18. In this embodiment of the invention, the flow of a coating material is constricted by means of adjusting pin 19 functioning as control elements. Each adjusting pin 19 is adapted for a lengthwise displacement into such boring 19a. These lengthwise displaceable adjusting pin are now operated directly by said actuator 42.

The adjusting pin has its inner end 23, extending into the feed hole 18, preferably bevelled. The adjusting pin 19 is sealed in the boring 19a by means of packings 22. The feed holes 18 have a mutual distance lengthwise of the nozzle element of e.g. 50-600 mm, preferably 150-300 mm. Consequently, the thickness of a coating layer can be locally manipulated at an accuracy of sequences equal to spacing distances between said feed holes. Respectively, the cross-profile of a coating material layer is thus also adjustable by means of the method at a substantially equal accuracy.

Naturally, the feed rate of a coating material between the feed chamber 12 and the feed slot 30 can be regulated by using other regulating elements, as well. FIG. 4 illustrates a nozzle beam design, in which the regulation of a coating material feed rate is in turn effected by means of a profiling member 15, disposed in the equalizing chamber 13, and by regulating shanks 16 operating the same. For the sake of clarity, only one nozzle member 39 of the nozzle beam 40 is depicted in this figure. Thus, in this embodiment the actuator 42 is connected to these elements 15, 16. The profiling member 15 is located on a surface of the equalizing chamber provided with the feed holes 14, extending over a distance defined by the successive feed holes. The effective area of flow channels is modified by adjusting the profiling member 15 in terms of its position lateral to the longitudinal axis in the direction indicated by an arrow D. By using the bar to manipulate the size of a feed hole, regarding either a single feed hole or a cluster of several feed holes, the flow rate of a coating material from the feed chamber 12 to the equalizing chamber 13 can be regulated locally at various points of its lengthwise dimension. The regulating shanks 16, functioning as regulating elements, have a mutual spacing lengthwise of the nozzle beam, i.e. in the direction of a cross-coating profile, which is e.g. 50-600 mm, preferably 150-300 mm.

It is an objective in a method of the invention to subject the feed rate, with regard to each individual coating material layer, to such a local regulation that the cross-profile of each coating material layer turns out as desired. A particular objective is to eliminate all deviations from a desired cross-profile. Thus, it is not absolutely necessary in the method to strive for a perfectly straight cross-profile. By means of a method of the invention, it is, for example, possible to compensate for deformations taking place in a paper web towards the end of a dryer section in a paper machine, such as, for example, warping of paper at the edges. In this case, the feed of a coating material from a feed chamber to a feed slot is regulated locally in such a way that the coating material layer shall become in its edge regions either thinner or thicker than in the middle of a web, thereby compensating for changes in the web thickness at the end of a drying process.

If a nozzle beam is provided with automated cross-profile control, it is possible, on the basis of a measurement conducted upon a flow plane of the nozzle beam, to adjust the cross-profile precisely as desired, totally without quality measuring instruments. The method enables also the cross-profile optimization for all layers, which is most of the time impossible with traditional quality measurements and nozzle beam adjustments. A cross-profile as straight and consistent as possible or generally as desired for the overall coating can be created for example in such a way that other individual coating material layers are adjusted as desired with regard to their cross-sections and the thickness-regulation of the entire coating is conducted by means of a single layer having a thickness which is considerable with respect to the overall coating thickness. Thus, no particular cross-profile is sought for in this layer, but the profile for said layer is adjusted in such a way that it is definitely the cross-profile of an entire coating which shall be obtained as desired.

For example in a three-layer coating, as in the above exemplary embodiment, the amounts of coating in top and bottom layers are small, typically in the order of 2-4 g/m². On the other hand, the middle layer has a substantially larger thickness, for example 8-15 g/m². As a result of this, even high-percentage changes in the cross-profiles of top and bottom layers do not call for major compensatory modifications in the middle layer to provide a consistent cross-profile for the entire coating.

According to the invention, the cross-profile regulation of each coating material layer is preferably enhanced by using a coating-layer specific control of the by-pass rate as auxiliary means. Increasing or decreasing the by-pass of a coating material can be applied for an impact on the cross-profile of a coating layer. This type of regulation occurs definitely at a rough level. The fine adjustment of a cross-profile is effected by regulating the feed-flow rate of a coating material. By using a by-pass as auxiliary regulation, it is accordingly possible to reduce the need of regulating between the feed chamber 12 and the nozzle slot 30 the flow rate specific to a given coating material layer.

Another essential advantage of the invention lies in the fact that, since the measurement of a cross-profile is conducted as early as on the flow plane 35 of a nozzle beam, the adjustment procedures necessary for regulating the cross-profile of coating material layers can be performed prior to starting the actual coating process. This makes it possible to achieve a prime-quality coating right from the start of a coating process, even if modifications had been made to feed rates or properties of the slip.

According to optional procedures in a method of the invention, the disposition and number of sensors used for a measurement conducted upon the flow plane of a nozzle beam—hence, this refers to the measuring elements of any measuring instrument based on non-contact measuring—can be implemented with a wide variety of alternatives. If the sensors are mounted on a frame 43 shown in FIG. 2, which is traversing, i.e. movable crosswise to the traveling direction of a web W, the measurement can be conducted across the entire web for each individual coating material layer by using just one group of sensors.

It is possible to make sensors movable also in the traveling direction of a web, in which case the thickness of each individual coating material layer upon the flow plane of a nozzle beam can be measured by means of one single sensor. On the other hand, sensors may also be made stationary, such that there are sensors disposed in equally spaced rows for each coating material layer across the entire width of a web. The cross-profile of a coating material layer is found out on the basis of measuring information provided by such an array of sensors. Preferably, for example, the sensors are disposed in such a way that there is at least one sensor 44 for each adjusting pin 19. Thus, the adjustment of a coating material flow rate is conducted on the basis of measuring results provided by a relevant sensor.

According to one further aspect of the invention, the use of actuators is possible not only for the regulation of a cross-coating profile but also of a machine-directed coating profile. The coating thickness can be regulated in a desired direction consistently over the entire cross-profile and, especially, concurrently with the on-going run.

According to one further aspect of the invention, it is also conceivable that, in addition to measuring the coating from a plane, another measurement is conducted from a curtain formed by the coating material layers prior to application to a fibrous web. The measurement can be carried out as a high-speed measurement, most conveniently by means of laser measuring.

1-10. (canceled)

11. A method of coating a paper/board web with a plane-fed curtain coater, comprising the steps of:
feeding at least one layer of a coating material from at least one feed chamber through a nozzle feed slot onto a flow plane established by a cross machine direction extending nozzle beam;
flowing the at least one layer of coating material in a machine direction along the flow plane;
determining a cross machine direction thickness profile downstream of the nozzle feed slot of said at least one coating material layer on top of the flow plane; and
controlling on the basis of the cross machine direction thickness profile, a feed rate of the coating material from the feed chamber to the feed slot to achieve a selected cross machine direction thickness profile for said at least one coating material layer.

12. The method of claim 11, wherein the step of feeding includes feeding a plurality of superpositioned coating layers on to the flow plane, each layer supplied with a coating from a feed chamber through a nozzle feed slot, the plurality of superpositioned coating layers forming a total coating layer; and wherein the step of determining a cross machine direction thickness profile downstream of the nozzle feed slot of said at least one coating material layer on top of the flow plane includes determining a cross machine direction thickness profile of each coating layer; and wherein the step of controlling on the basis of the cross machine direction thickness profile, a feed rate of the coating material from the feed chamber to the feed slot includes controlling on the basis of each cross machine direction thickness profile, a feed rate of each coating material from each feed chamber to each feed slot to achieve a selected cross machine direction thickness profile for said total coating layer.

13. The method of claim 11 wherein the step of controlling on the basis of the cross machine direction thickness profile, further comprises increasing or decreasing a by-pass flow of the coating material through the feed chamber.

14. The method of claim 11, wherein the step of determining the cross machine direction thickness profile is accomplished with at least one sensor making a non-contact measurements of thickness.

15. The method of claim 14, wherein said at least one sensor is moved in a cross machine direction along the nozzle beam, such that the cross machine direction thickness profile is conductible with said sensor essentially across the entire width of the web.

16. The method of claim 11, wherein the step of determining the cross machine direction thickness profile is accomplished by measuring a surface speed of the at least one layer of coating material as it flows in the machine direction along the flow plane.

17. The method of claim 11, wherein the step of controlling on the basis of the cross machine direction thickness profile, the feed rate of the coating material from the feed chamber to the feed slot to achieve a selected cross machine direction thickness profile for said at least one coating material layer, further comprises:
manipulating an element disposed in each of a plurality of cross machine direction arrayed feed holes which communicate between said at least one feed chamber and the nozzle slot whereby the effective area of the feed holes is adjusted so that the at least one layer of the coating material achieves the selected cross machine direction thickness profile for said at least one coating material layer.

18. The method of claim 17, wherein the coating material flowing between said at least one feed chamber and the nozzle slot flows through at least one equalizing chamber, which extends in the cross machine direction and into which equalizing chamber the feed holes open.

19. A method of coating a paper/board web with a plane-fed curtain coater, comprising a cross machine direction extending nozzle beam provided with at least a first feed chamber and a first nozzle feed slot connected to the first feed chamber, and a second feed chamber and a second nozzle feed slot connected to the second feed chamber, comprising the steps of:
feeding a first layer of first coating material from the first nozzle feed slot on top of a flow plane defined by the nozzle beam, and flowing the first layer in a machine direction along the flow plane;
feeding a second layer of second coating material from the second nozzle feed slot on top of the flow plane defined by the nozzle beam, and flowing the second layer in the machine direction along the flow plane;
determining a cross machine direction thickness profile of at least one of the first layer of coating material or the second layer of coating material, on top of the flow plane downstream of the first nozzle feed slot, or the second nozzle feed slot respectively; and
controlling a first feed rate of the first coating material from the first feed chamber to the first nozzle feed slot, or controlling a second feed rate of the second coating material from the second feed chamber to the second nozzle feed slot, on the basis of the determined cross machine direction thickness profile of respectively the first layer of coating material or the second layer of coating material, to achieve a selected cross machine direction thickness profile for said at least one of the first layer of coating material or the second layer of coating material.

20. The method of claim 19 wherein the step of controlling on the basis of the determined cross machine direction thickness profile of the first layer of coating material or the second layer of coating material, further comprises increasing or decreasing a by-pass flow of the coating material through the first feed chamber or the second feed chamber.

21. The method of claim 19 wherein the step of determining a cross machine direction thickness profile of at least one of the first layer of coating material or the second layer of coating material is accomplished with at least one sensor making non-contact measurements of thickness.

22. The method of claim 21 wherein said at least one sensor is moved in a cross machine direction along the nozzle beam, such that the cross machine direction thickness profile is conductible with said sensor essentially across the entire width of the web.

23. The method of claim 19, wherein the step of determining the cross machine direction thickness profile is accomplished by measuring a surface speed of the first layer of coating material or the second layer of coating material, as it flows in the machine direction along the flow plane.

24. A plane-fed curtain coater, comprising:
a nozzle beam extending in a cross machine direction, having a flow plane defined by the nozzle beam, and having portions defining at least a first feed chamber and a first nozzle feed slot connected to the first feed chamber, and a second feed chamber and a second nozzle feed slot connected to the second feed chamber;
a web positioned below the nozzle beam in coating receiving relation, the web arranged to travel in a machine direction below the nozzle beam, wherein the web defines a width in the cross machine direction, and wherein the first nozzle feed slot and the second nozzle feed slot extend at least across the defined width in the cross machine direction;
a measuring element positioned above the flow plane defined by the nozzle beam, the measuring element of a type for determining a thickness profile, the measuring element arranged for measuring a cross machine direction thickness profile of at least one coating material layer on top of the flow plane across a width corresponding to the entire width of the web;
a plurality of regulating elements positioned between the first nozzle feed chamber and the first nozzle feed slot, or between the second feed chamber and the second nozzle feed slot, and arranged for regulating a feed rate of a coating material between respectively the first feed chamber, and the first nozzle feed slot, or between the second feed chamber and the second flow nozzle feed slot, wherein the measuring element is in data transmitting relation to apparatus arranged in controlling relation to the regulating elements.

25. The plane-fed curtain coater of claim 24, wherein said measuring element is a sensor mounted for movement in a cross machine direction along the nozzle beam, such that a cross machine direction thickness profile is conducted when said sensor moves essentially across the entire width of the web.

26. The plane-fed curtain coater of claim 24, wherein said measuring element comprises a plurality of sensors mounted spaced apart in the cross machine direction and positioned over the nozzle beam.

27. The plane-fed curtain coater of claim 24, wherein said measuring element is a sensor of a type that is arranged to measure a surface speed of a flowing layer of coating.

28. The plane-fed curtain coater of claim 24, wherein said measuring element is a sensor of a type that is arranged to measure a surface speed in a non-contact way based on laser technology.
